(19) United States
(12) Patent Application Publication
(10) Pub. No.: US 2009/0066849 A1
(43) Pub. Date: Mar. 12, 2009

(54) DISPLAY APPARATUS AND TV TUNER MOUNTED THEREOF

(75) Inventors: LUNG DAI, Tu-Cheng (TW); SHIH-LUNG HSU, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/967,012

(22) Filed: Dec. 29, 2007

(30) Foreign Application Priority Data
Sep. 7, 2007 (CN) 200710201622.0

(51) Int. Cl. H04N 5/50

(52) U.S. Cl. 348/731; 348/E05.097

(57) ABSTRACT

A display apparatus includes a display panel, a front cover, a rear cover, and a TV tuner. The front cover and the rear cover are packaged together to form an accommodating space. The display panel and the TV tuner are accommodated in the accommodating space. The TV tuner includes a main body and an antenna input terminal. The main body has a first surface. The antenna input terminal projects from the first surface. The antenna input terminal extends downward and outward with respect to the display panel.

### BACKGROUND

1. Field of the Invention

The present invention generally relates to display apparatuses, and more particularly, relates to a display apparatus mounted with a TV tuner.

2. Description of Related Art

In recent years, display apparatuses such as liquid crystal display (LCD) and plasma display panel (PDP) are widely used as television.

Generally, a TV tuner is often built within the display apparatus. The TV tuner is used for receiving a radio frequency (RF) signal through an antenna, converting the RF signal to an intermediate frequency (IF) signal, demodulating the IF signal, and generating compressed video and audio signal thereof.

Such a TV tuner includes an antenna input terminal and a plurality of output terminal pins. The output terminal pins projecting vertically with respect to a main body of the TV tuner are coupled to a main printed circuit board (PCB) of the display apparatus. The PCB is disposed in parallel with a display screen of the display apparatus. In order to reduce an overall thickness of the display apparatus, the antenna input terminal of the TV tuner is also disposed in parallel with the display screen and the PCB. With this arrangement, the antenna input terminal extends downward with respect to the display apparatus.

However, it is troublesome and time-consuming for a user to connect an antenna wire to the antenna input terminal from underside of the display apparatus. To solve this problem, an antenna support connector formed in an L-shaped is used to extend the antenna input terminal in a direction perpendicular to the display screen.

This structure allows the user to easily connect the outer antenna wire to the antenna input terminal from a rear side of the display apparatus. However, a problem with this structure is that a cost is increased for using the L-shaped antenna support connector.

Therefore, what is needed in the industry is to provide a cost effective TV tuner for solving the problems described above.

### SUMMARY

Accordingly, a display apparatus is provided. The display apparatus includes a display panel, a front cover, a rear cover, and a TV tuner. The front cover and the rear cover are assembled together to form an accommodating space. The display panel and the TV tuner are accommodated in the accommodating space. The TV tuner includes a main body and an antenna input terminal. The main body has a first surface. The antenna input terminal projects from the first surface. The antenna input terminal extends outward and downward with respect to the display panel.

### BRIEF DESCRIPTION OF THE DRAWINGS

FIG. 1 is a partially broken side view of a display apparatus with a TV tuner mounted thereof in accordance with an exemplary embodiment.

FIG. 2 is a perspective view of the TV tuner in FIG. 1.

FIG. 3 is a side view of the TV tuner in FIG. 1.

FIG. 4 is a using state view of the display apparatus in FIG. 1.

### DETAILED DESCRIPTION

Reference will now be made in detail to the exemplary embodiments of the display apparatus, examples of which are illustrated in the accompanying drawings.

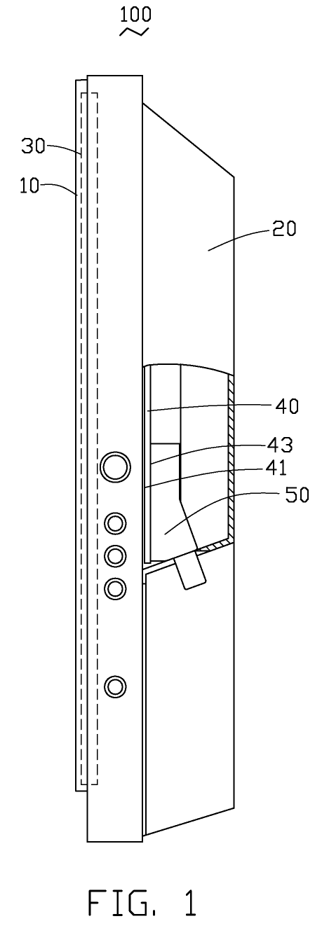

Referring to FIG. 1, a display apparatus 100 can be used as a monitor or as a television set. The display apparatus 100 includes a front cover 10, a rear cover 20, a display panel 30, a main printed circuit board (PCB) 40, and a TV tuner 50. The front cover 10 and the rear cover 20 are packaged together to form an accommodating space (not shown). The display panel 30, the main PCB board 40, and the TV tuner 50 are accommodated in the accommodating space.

The main PCB 40 includes two opposite side surfaces 41 and 43 that are parallel with a display surface (not shown) of the display panel 30. Herein, the “display surface” denotes a front surface facing outwards and configured for displaying graphics or images. The TV tuner 50 is removeably attached to the side surface 43 of the main PCB 40 and configured for providing video signals and/or audio signals generated from radio frequency (RF) signals to the main PCB 40.

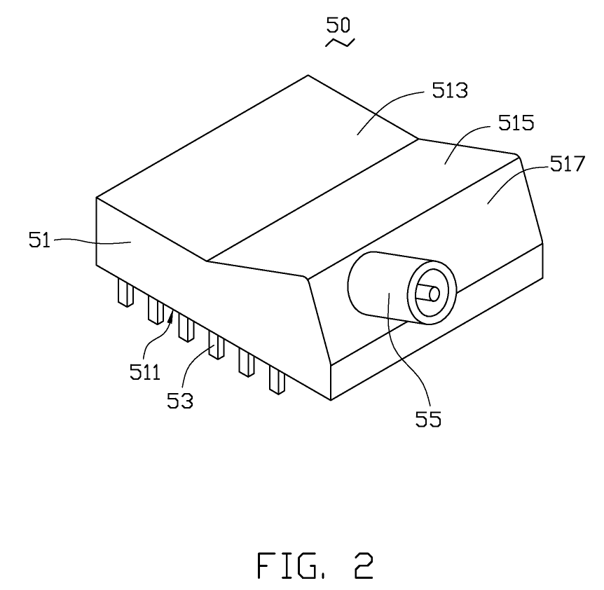

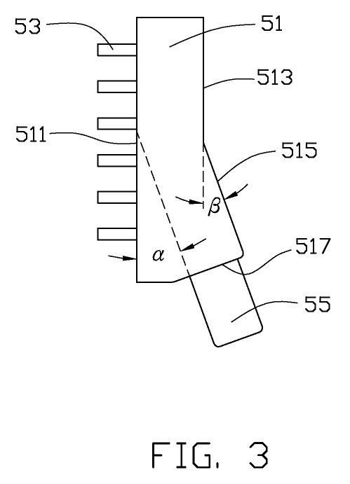

Referring to FIGS. 2, 3, the TV tuner 50 includes a main body 51, an antenna input terminal 55, and a plurality of output terminal pins 53. The antenna input terminal 55 and the output terminal pins 53 are formed on the main body 51. The main body 51 is a polyhedron and includes a plurality of side surfaces such as a first surface 517, a second surface 511, a third surface 515, and a fourth surface 513. The second surface 511 extends substantially parallel with the fourth surface 513. An edge of the fourth surface 513 is connected to an edge of the third surface 515 and the third surface 515 is inclined relative to the second surface 511 and fourth surface 513. The third surface 515 extends obliquely along a direction away from the second surface 511. An acute angle α is referenced by an extending direction of the antenna input terminal 55 relative to the second surface 511. A dihedral angle β is also an acute angle referenced by an extending direction of the fourth surface 513 and the third surface 515. In the embodiment, the angle α and β are 20 degrees. The angle α and β may also range from about 10 degrees to about 45 degrees in other embodiments. The first surface 517 connects to another edge of the third surface 515 and extends perpendicularly relative to the third surface 515 to approach the second surface 511.

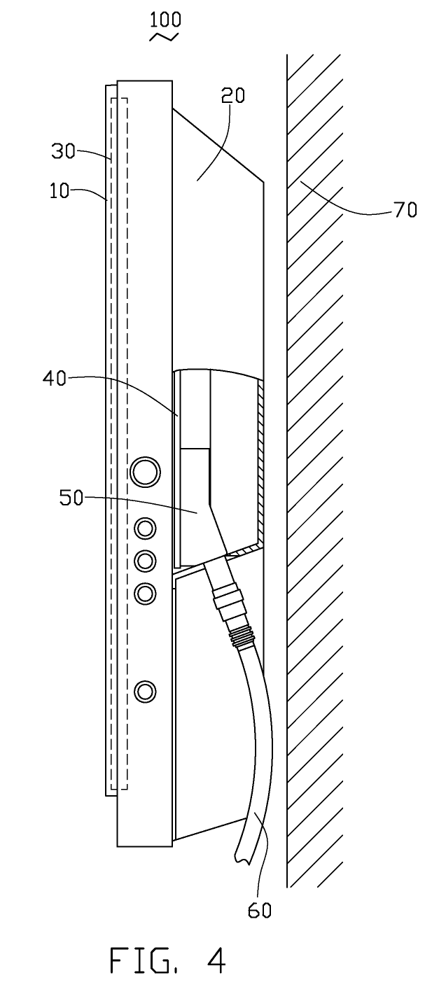

The antenna input terminal 55 protrudes from the first surface 517. The antenna input terminal 55 extends in a first direction perpendicular to the first surface 517 and parallel with the third surface 513. The antenna input terminal 55 is connected to an antenna cable 60 (see FIG. 4) for receiving the RF signals and transmitting the RF signals to internal circuits (not shown) of the TV tuner 50. The output terminal pins 53 project from the second surface 511. The output terminal pins 53 extend parallel with each other in a second direction and perpendicularly to the second surface 511. The output terminal pins 53 are connected to the main PCB 40 for outputting the IF signals converted from the RF signals to the PCB 40.

Referring to FIG. 4, in assembly, the TV tuner 50 is coupled to the main PCB 40 by inserting the output terminal pins 53 into corresponding locations of the PCB 40. The antenna input terminal 55 protrudes out of the rear cover 20 from a through hole (not labeled) defined in the rear cover 20. The antenna cable 60 can be easily connected to the antenna input terminal 55, as the antenna input terminal 55 extends outward and downward relative to the display panel 30 and the main PCB 40.

According to the embodiment disclosed, because there is no need to use L-shaped antenna support connector, the cost of the TV tuner is reduced accordingly.

Moreover, when the display apparatus 100 is mounted to a wall 70, the slantwise designed antenna input terminal 55 is conformed to an ergonomic design, such that the antenna cable 60 is easily to be connected to the antenna input terminal 55. Therefore, an efficiency is improved when the antenna cable 60 is connected to the antenna input terminal 55.

The foregoing description of the exemplary embodiments of the invention has been presented only for the purposes of illustration and description and is not intended to be exhaustive or to limit the invention to the precise forms disclosed. Many modifications and variations are possible in light of the above teaching. The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A TV tuner, comprising:
a main body comprising a first surface and a second surface;
an antenna input terminal protruding from the first surface for receiving radio frequency signals; and
a plurality of output terminal pins protruding perpendicularly from the second surface of the main body for outputting electrical signals converted from the radio frequency signals, the antenna input terminal extending in a direction to form an acute angle relative to the second surface.

2. The TV tuner as claimed in claim 1, wherein the antenna input terminal protrudes perpendicularly relative to the first surface.

3. The TV tuner as claimed in claim 1, wherein the acute angle ranges from 10 degrees to 45 degrees.

4. The TV tuner as claimed in claim 3, wherein the acute angle is 20 degrees.

5. The TV tuner as claimed in claim 3, wherein the main body further comprises:
a third surface, the third surface is perpendicularly connected to the first surface; and
a fourth surface, the fourth surface is connected to the third surface and extends parallel with the second surface.

6. A display apparatus, comprising:
a printed circuit board; and
a TV tuner removeably attached to the printed circuit board, the TV tuner comprising:
a main body comprising a first surface;
an antenna input terminal projecting from the first surface, the antenna input terminal extending slantwise relative to the printed circuit board.

7. The display apparatus as claimed in claim 6, wherein the TV tuner further comprises a plurality of output terminal pins projecting from a second surface of the TV tuner, the second surface extends along a direction which forms an acute angle with the first surface.

8. The display apparatus as claimed in claim 7, wherein the output terminal pins project perpendicularly to the second surface.

9. The display apparatus as claimed in claim 6, wherein the antenna input terminal projects perpendicularly to the first surface.

10. The display apparatus as claimed in claim 6, wherein the acute angle ranges from 10 degrees to 45 degrees.

11. The display apparatus as claimed in claim 10, wherein the acute angle is 20 degrees.

12. The display apparatus as claimed in claim 6, wherein the main body of the TV tuner further comprises:
a third surface perpendicularly connecting to the first surface; and
a fourth surface connecting to the third surface and extending parallel with the second surface.

13. A display apparatus, comprising:
a front cover;
a rear cover packaged together with the front cover to form an accommodating space;
a display panel; and
a TV tuner, the display panel and the TV tuner accommodated in the accommodating space, the TV tuner comprising:
a main body comprising a first surface; and
an antenna input terminal projecting from the first surface, the antenna input terminal extending downward and rearwardly relative to the display panel.

14. The display apparatus as claimed in claim 13, wherein the antenna input terminal projects perpendicularly to the first surface.

15. The display apparatus as claimed in claim 13, wherein the TV tuner further comprises:
a plurality of output terminal pins projecting perpendicularly to a second surface of the TV tuner.

16. The display apparatus as claimed in claim 13, wherein the TV tuner is detachably attached to a printed circuit board of the display apparatus.

17. The display apparatus as claimed in claim 13, wherein the antenna input terminal extends to form an acute angle with the display panel.

18. The display apparatus as claimed in claim 13, wherein the acute angle ranges from 10 degrees to 45 degrees.

19. The display apparatus as claimed in claim 13, wherein the acute angle is 20 degrees.

20. The display apparatus as claimed in claim 15, wherein the main body of the TV tuner further comprises:
a third surface, the third surface perpendicularly connecting to the first surface; and
a fourth surface, the fourth surface connecting to the third surface and extending parallel with the second surface.
